(19) United States
(12) Patent Application Publication
(10) Pub. No.: US 2018/0299365 A1
(43) Pub. Date: Oct. 18, 2018

(54) CYTOMETRIC METHOD AND CYTOMETER UNIT

(71) Applicant: Testo SE & Co. KGaA, Lenzkirch (DE)

(72) Inventors: Robert Rieger, Freiburg (DE); Philipp Von Olshausen, Freiburg (DE)

(73) Assignee: Testo SE & Co. KGaA, Lenzkirch (DE)

(21) Appl. No.: 15/566,387

(22) PCT Filed: May 2, 2016
(86) PCT No.: PCT/EP2016/000710

§ 371 Date: Oct. 13, 2017

(30) Foreign Application Priority Data
May 2, 2015 (DE) 10 2015 005 656.5

(51) Int. Cl. G01N 15/14; G01N 21/64

(52) U.S. Cl. CPC G01N 15/1434; G01N 2021/6482; G01N 2015/1452; G01N 21/645

(57) ABSTRACT

In the case of a cytometer unit (1) comprising a receptacle (2), which is configured for the insertion of an exchangeable sample carrier (3) and in which an optical path (4) for carrying out a cytometric measurement is implemented, it is proposed to bleach the sample carrier (3) in a region (10) around a sensitive region (18) predefined by a detector arrangement (8) and/or to alter a position of the optical path (4) on the inserted sample carrier (3) using an alteration means (16).

### BACKGROUND

The invention relates to a cytometry method, wherein in a cytometric measurement a cytometer channel embodied in a sample carrier and containing a sample to be examined is introduced into an optical path, wherein the optical path defines a region of action on the sample carrier and a detector arrangement defines a sensitive region on the sample carrier.

The invention furthermore relates to a cytometer unit, comprising a receptacle for an insertable sample carrier, wherein a rotation unit which can be coupled to an inserted sample carrier is arranged in the receptacle, by means of which rotation unit the sample carrier inserted into the receptacle is rotatable, and wherein an optical path for carrying out a cytometric measurement on a cytometer channel of the inserted sample carrier is implemented in the receptacle. Preferably, the receptacle is implemented for insertion of a sheet-shaped sample carrier, for example in a slot-shaped fashion.

Cytometry methods are known and are used for example to perform counting examinations and/or substance analyses on a sample. To that end, it is known to use cytometer units for performing a cytometry method. In the known cytometry methods, it is desirable to keep the sample to be examined in a sample carrier, wherein for a standardized and/or frequent performance of the cytometry method the cytometer channel is best implemented on the sample carrier itself.

It has been found that an accurate alignment of the cytometer channel in relation to the optical path is required before the beginning of the actual cytometric measurement. To that end, various means have been proposed, but stringent requirements in respect of the accuracy of the alignment have to be complied with. An attempt could therefore be made, after a coarse alignment, to achieve a fine adjustment of the alignment by seeking, preferably in an automated manner, an alignment for which a measurement signal has a particularly suitable characteristic. In this case, however, it had been found that the sample carrier itself can react to action of light, such that it is difficult to detect and evaluate a meaningful alteration of the measurement signal by means of an alteration of the alignment of the cytometer channel relative to the optical path.

The sample carrier used is preferably implemented in a sheet-shaped fashion in the case of the invention. The sheet shape can be characterized for example by the fact that the sample carrier has a significantly smaller dimension in one direction—for example in its thickness—than in the two directions (for example its length and width) complementary to said direction. In this case, the sample carrier can have any desired basic shape or contour, for example can be implemented as circular, triangular, quadrilateral, in particular rectangular, polygonal or angular-segment-shaped.

### SUMMARY

The invention is based on the object of improving the automated fine alignment.

In order to achieve this object, a cytometry method with one or more features according to the invention is provided. In particular, therefore, in order to achieve the abovementioned object, in the case of a cytometry method of the type described in the introduction, it is proposed that the sample carrier consists of a fluorescent, light-transmissive material at least in a region of the cytometer channel, and that the fluorescent, light-transmissive material is bleached by action of light before the cytometric measurement. What is advantageous here is that the material of the sample carrier is optically deactivatable by the bleaching, such that afterward a fine adjustment can be performed by displacement of the sensitive region on the sample carrier and evaluation of the output signal. An influencing of the output signal for the preparation of the cytometric measurement and for the fine alignment of the sensitive region during the displacement of the sensitive region into the sample carrier can thus be reduced or can even be entirely avoided by virtue of the fact that the intrinsic fluorescence of the material of the sample carrier is at least temporarily suppressed or at least reduced by the bleaching. In this case, the region can comprise the region of action already mentioned.

Alternatively or additionally, in order to achieve the abovementioned object, in the case of a cytometry method of the type described in the introduction, provision can be made for a position of the optical path on the sample carrier to be altered in such a way that before the cytometric measurement an output signal of the detector arrangement has an improved signal quality. What is advantageous here is that an automated fine adjustment is made possible. It is particularly expedient here if this alteration of the position of the optical path is performed after or during the already described bleaching according to the invention by action of light. Consequently, the already mentioned intrinsic fluorescence of the material can be suppressed for the purposes of the fine adjustment.

In this case, provision can be made for the size of the sensitive region to be predefined by a stop upstream of the detector device. Generally, it is expedient if the size of the sensitive region is dimensioned such that the cytometer channel can be completely covered in its cross section. What can be achieved in this way is that all particles in the sample to be examined are detectable. It has been found to be expedient to define the sensitive region such that as little surrounding sample carrier material as possible is concomitantly detected. An expedient signal-to-noise ratio can be achievable in this way. Provision can be made here, for example, for the sensitive region to be at most 10% greater than the extension of the cytometer channel in cross section, for example equal to the extension of the cross section.

Instead of the stop, the size of the sensitive region can also be given by the detector geometry itself or an upstream optical unit.

For the assessment of the output signal, it is expedient if the sample or some other evaluatable medium is already situated in the cytometer channel. By way of example, an autofluorescence of the liquid sample material can be used here.

For the actual cytometric measurement, instead of said output signal it is subsequently possible to evaluate a selective output signal which is oriented for example toward individual particles. This can be configured electronically.

For this purpose, by way of example, a uniform average value of a recorded intensity of the output signal is optimized during the fine adjustment. In a subsequent cytometric measurement, the output signal can then be temporally resolved such that temporal maxima or extrema are detectable. Individual particles can be detected in this way.

In one configuration of the invention it can be provided that a fluorescent material of the sample carrier, for example the material already mentioned, is bleached by action of light in a part of the region of action into which the sensitive region is intended to be brought by the alteration of the position of the optical path. What is advantageous here is that it is possible to reduce or suppress an influencing of the abovementioned output signal by intrinsic fluorescence of the material upon alteration of the position of the optical path.

In one configuration of the invention it can be provided that the position of the optical path is altered by means of an adjustable mirror arrangement. Consequently, the position of the optical path is variable and finely adjustable in a particularly simple manner, in particular with a stationary sample carrier.

In one configuration of the invention it can be provided that the position of the optical path is set by means of a feedback loop coupled to an output signal, for example to the output signal already mentioned. What is advantageous here is that an automatic fine adjustment to the most sensitive part of the optical path and/or the most sensitive region of the cytometer channel is made possible. The feedback loop can be configured for example for improving a signal quality and/or for improving a signal-to-noise ratio.

In one configuration of the invention it can be provided that the region of action covers the sensitive region. What is advantageous here is that a bleaching according to the invention can already be carried out in proximity to the sensitive region. What can thus be achieved in a simple manner is that upon a displacement of the sensitive region by alteration of the relative position of the optical path relative to the cytometer channel the sensitive region is brought into prebleached material of the sample carrier. Intrinsic fluorescences of the material can thus be suppressed in a simple manner during the fine adjustment in the output signal.

In one configuration of the invention it can be provided that the position of the optical path is altered transversely with respect to an extension direction of the cytometer channel. A cross section of the cytometer channel is thus optimally detectable.

In one configuration of the invention it can be provided that the region of action is illuminated with a light curtain whose cross section has a first extent along an extension direction of the cytometer channel and a second extent transversely with respect to the extension direction of the cytometer channel, wherein the first extent is smaller than the second extent. In this case, the first extent and the second extent are aligned in each case transversely or perpendicularly to the beam direction of the light curtain. What is advantageous here is that a quantity of light can be utilized particularly effectively for focusing onto the cytometer channel, on the one hand, and for bleaching adjacent regions of the cytometer channel, on the other hand. The use of the light curtain is particularly expedient if the position of the optical path is altered transversely with respect to the extension direction of the cytometer channel. What is achievable in a simple manner in this way is that a displacement of the optical path and thus a displacement of the sensitive region in the sample carrier leads into parts of the material of the sample carrier which have already been prebleached.

It is particularly expedient here if the first extent is coordinated with a size of a sensitive region, for example of the sensitive region already mentioned. Consequently, an expedient focusing of the optical path along the extension direction of the cytometer channel is achievable. Alternatively or additionally, provision can be made for the second extent to be coordinated with a size of a region of action, for example of the region of action already mentioned. What is advantageous here is that bleaching can be performed in a large region, for example in the region of action.

In order to achieve the abovementioned object, alternatively or additionally the features of the independent claim directed to a cytometer unit are provided according to the invention. In particular, therefore, in the case of a cytometer unit of the type described in the introduction, the invention proposes that there is implemented a means for bleaching the sample carrier at least in a region around the cytometer channel by action of light. What is advantageous here is that intrinsic fluorescences of the sample carrier which would have a disturbing effect during an automatic fine adjustment on the basis of an output signal can be suppressed or at least reduced. Consequently, in the case of the invention, it is not necessary to wait until the intrinsic fluorescences have decayed by themselves during the fine adjustment. A waiting time between individual adjustment steps during the fine adjustment can thus be dispensed with. The region of the cytometer channel can for example be coverable or described by the region of action and/or by an adjustment region.

In one configuration of the invention it can be provided that the means for bleaching comprises at least one beam-shaping lens arrangement. What is advantageous here is that a large region can be bleached. The beam shaping can be configured for implementing a non-round cross section of the optical path, for example by forming a light curtain. What is advantageous here is that in one dimension of the cross section it is possible to achieve a focusing and in a second dimension of the cross section it is possible to achieve a wide illumination for the purpose of bleaching. Preferably, the second dimension is aligned transversely with respect to an extension direction, for example the extension direction mentioned, of the cytometer channel.

Alternatively or additionally, provision can be made for the means for bleaching to comprise at least one adjustable mirror arrangement. What is advantageous here is that it is possible to shift a region of action on the sample carrier in order to bleach the sample carrier in the largest possible region.

In one configuration of the invention it can be provided that an adjustability of a sensitive region defined by a detector arrangement is delimited by the region around the cytometer channel. What is advantageous here is that an adjustment of the sensitive region, for example during a fine adjustment, does not lead out of the bleached region. Consequently, disturbing influences of unbleached material of the sample carrier can be reduced or even entirely avoided. The fine adjustment can thus be performed more rapidly and in particular without long waiting times until the decay of an intrinsic fluorescence.

In a way of achieving the object with possibly independent inventive quality, in the case of the cytometer unit of the type described in the introduction, provision is made for there to be implemented an alteration means for altering a position of the optical path on the inserted sample carrier. What is advantageous here is that it is possible to perform a fine adjustment of the optical path in relation to the sample carrier and in particular to the cytometer channel. It is particularly expedient if the alteration means is implemented for altering the position of the optical path with a fixed sample carrier and thus a stationary cytometer channel. Consequently, the sample carrier can be fixed after a coarse adjustment in order to determine a most expedient point of application of the optical path on the sample carrier in a fine adjustment.

In one configuration of the invention it can be provided that the alteration means has an adjustable mirror arrangement. A simple means of adjusting and/or setting the position of the optical path with a fixed or stationary sample carrier is thus provided.

In one configuration of the invention it can be provided that the alteration means are configured for adjusting a position of the sensitive region and/or of the region of action on the inserted sample carrier transversely with respect to an extension direction of the cytometer channel. A coordination of the region of action and in particular of the sensitive region with a cross section of the cytometer channel can thus be performed.

In one configuration of the invention it can be provided that a feedback loop coupled to an output signal of an electrical unit that performs the cytometric measurement is configured for driving the alteration means. What is advantageous here is that an automatic adjustment can be carried out on the basis of the output signal. To that end, provision can be made, for example, for the cytometric measurement to be carried out on a test basis in order to evaluate the output signal, the alteration means being driven such that an output signal of the detector unit has for example a particularly expedient signal-to-noise ratio. It is particularly expedient here if the alteration means comprises an adjustable mirror, for example the adjustable mirror already mentioned.

Generally, provision can be made here for the region of action to be larger than the sensitive region. What is advantageous here is that the sensitive region is accommodated by the region of action. What can thus be achieved is that bleaching according to the invention of the material of the sample carrier can be performed adjacent to the sensitive region.

In one advantageous configuration it can be provided that there are implemented means for illuminating the region of action with a light curtain, wherein the light curtain has a cross section having a first extent along an extension direction of the cytometer channel and a second extent transversely with respect to the extension direction of the cytometer channel, wherein the first extent is smaller than the second extent. It is thus possible to perform bleaching according to the invention in adjacent regions along the adjustment movement of the sensitive region on the sample carrier. It is particularly expedient here if the first extent is coordinated with a size of the sensitive region. A focusing of the light beam along the extension direction is thus easily achievable. Alternatively or additionally, provision can be made for the second extent to be coordinated with a size of the region of action. It is thus possible to cover the largest possible area and in particular the largest possible path distance of an adjustment movement during the fine adjustment on the material for the bleaching according to the invention.

In this case, the illumination means, for generating the light curtain, can comprise a combination of a cylindrical lens with a spherical lens in order to achieve beam expansion in the second extent and focusing in the first extent.

The invention will now be described in greater detail on the basis of exemplary embodiments, but is not restricted to these exemplary embodiments. Further exemplary embodiments arise through combination of the features of individual or a plurality of claims among one another and/or with individual or a plurality of features of the exemplary embodiments.

### BRIEF DESCRIPTION OF THE DRAWINGS

In partly highly schematic illustration:

FIG. 1 shows a cytometer unit according to the invention for elucidating a cytometry method according to the invention,

FIG. 2 shows various cross and longitudinal sections through an optical path and a sample carrier in a cytometry method according to the invention, and

FIG. 3 shows a lens arrangement for generating an optical path in a cytometer unit according to the invention and a cytometry method according to the invention.

### DETAILED DESCRIPTION OF THE PREFERRED EMBODIMENTS

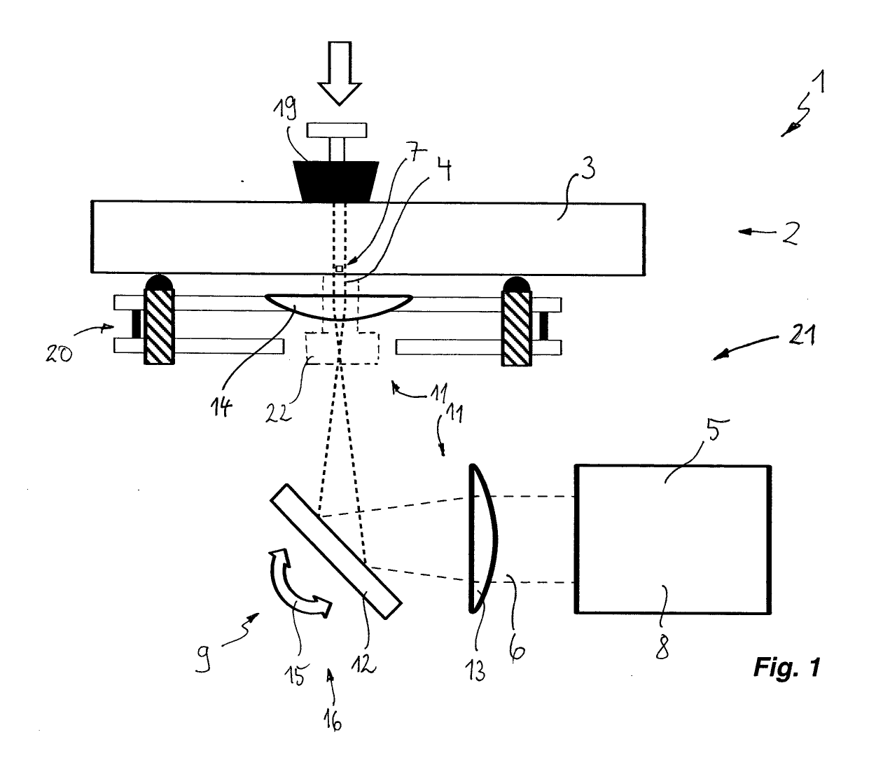

FIG. 1 shows for elucidation of the invention in highly simplified illustration a cytometer unit designated as a whole by 1. The cytometer unit has a receptacle 2, into which a sample carrier 3 can be inserted, said sample carrier being sheet-shaped here by way of example. In this case, the sample carrier 3 can be implemented as a quadrilateral sheet, in particular rectangular sheet, as a circular sheet, as a triangular sheet, as a polygonal sheet or as an angular-segment-shaped sheet (sheet in the shape of a wedge of cake) or as a sheet having some other basic shape or contour.

The cytometer unit 1 furthermore has a rotation unit 22, which is depicted only schematically in order to simplify the illustration. The rotation unit 22 can be coupled to the inserted sample carrier 3 in a manner known per se, in order to rotate said sample carrier about a rotation axis in the receptacle 2. By way of example, centrifuging can be carried out in this way.

An optical path 4 is implemented in the receptacle 2. A laser light generator 5 generates laser light 6, which is guided into the optical path 4 in a manner that will be described in more detail, and illuminates a cytometer channel 7 in the inserted sample carrier 3. As a result, a sample is optically excited in the cytometer channel 7 in a manner known per se. The excited sample itself emits light that is captured and recorded in a detector unit 8 during a cytometric measurement.

The cytometer channel 7 is implemented in a material of the sample carrier 3 which, upon irradiation with light, tends toward an intrinsic fluorescence that decays over the course of time.

In order to cause said intrinsic fluorescence to decay faster or not even to arise in the first place, the sample carrier 3 is bleached by action of light with the laser light 6 by a means 9 for bleaching in a region 10 around the cytometer channel.

In this case, the means for bleaching 9 has a lens arrangement 11 and an adjustable mirror arrangement 12.

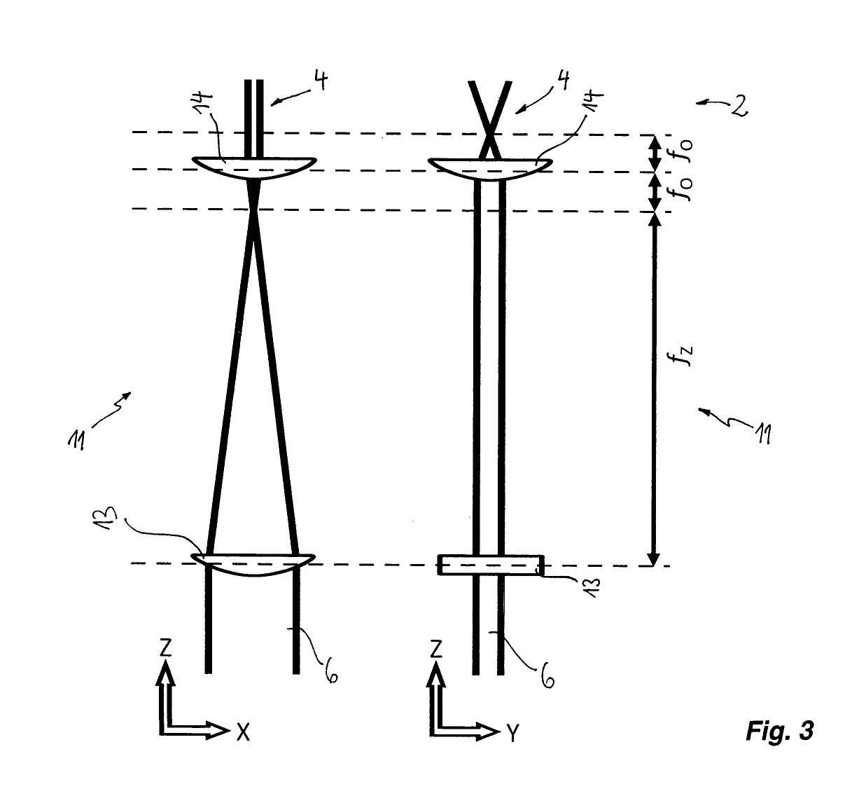

In this case, the lens arrangement 11 expands the light beam 6 in a direction transversely with respect to the optical path 4. This will be explained with reference to FIG. 3. FIG. 3 shows a sectional illustration through the lens arrangement 11 and the beam guiding in the left-hand half, and a sectional arrangement rotated by 90 degrees in the right-hand half.

It is evident that the lens arrangement 11 comprises a cylindrical lens 13 at an input side and a rotationally symmetrical objective lens 14, here for example an aspherical lens, at an output.

In the direction transversely with respect to the path of the light beam 6—here the Y-direction—in which the cylindrical lens 13 has no curvature, the light beam 6 is focused by the objective lens 14. The cytometer channel 7 of the inserted sample carrier 3 is situated at the focal point, at which the incident parallel beam is focused.

In the direction transversely with respect to the beam direction of the laser light 6—here the X-axis—in which the cylindrical lens 13 has a curvature, the incident laser light 6 is firstly collimated or parallelized and expanded again by the objective lens 14.

The extent of the optical path 4 given by the laser light emerging from the lens arrangement 11 therefore has (in the plane of the cytometer channel 7 or at the location of the sample carrier 3) a dimensioning that is many times greater in the X-direction than in the Y-direction. In this case, the X-direction lies transversely with respect to the extension direction of the cytometer channel 7.

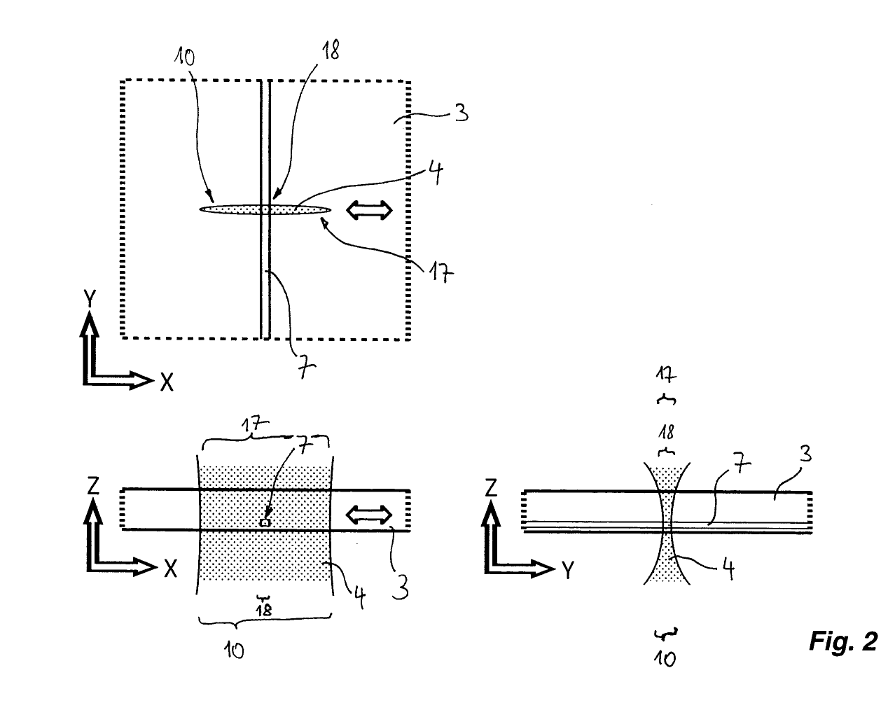

This is illustrated in FIG. 2. In this case, FIG. 2 shows at the bottom right a cross section through the optical path 4 and the sample carrier 3 in the Y-Z-plane, in the bottom left illustration a cross section through the optical path 4 and the sample carrier 3 in the X-Z-plane and, finally, in the top left illustration a cross section through the sample carrier 3 and the optical path 4 in the X-Y-plane, that is to say in the plane characterized by the sheet shape of the sample carrier 3.

FIG. 2 thus reveals that an optical path 4 having a non-round cross section is implemented by the lens arrangement 11. In this case, the extent of the cross section in the Y-direction can be 1 to 3 micrometers, for example, while the extent of the cross section in the X-direction can be a few 100 micrometers.

This expanded beam shape relative to the focusing forms a light curtain which covers a large region 10 around the cytometer channel 7 in the X-direction. The sample carrier 3 is bleached in the region 10.

The lens arrangement 11 and the laser light generator 5 thus form a means for illuminating 21 the sample carrier with a light curtain. By pivoting 15 or tilting the adjustable mirror arrangement 12, the light beam 6 can be directed into different parts of the sample carrier 3, such that a larger region 10 can be bleached with the light beam 6.

The adjustable mirror arrangement 12 is thus part of an alteration means 16 that can be used to alter the position of the optical path 4 on the inserted sample carrier 3.

The alteration means 16 thus allows the position of the optical path 4 to be accurately coordinated with the actual position of the cytometer channel 7.

The extent of the light beam 6 in the optical path 4 on the sample carrier 3 predefines a region 17 of action in which the sample carrier 3 is irradiated or illuminated with the laser light 6.

The detector arrangement 8 and the lens arrangement 11 define a sensitive region 18 as part of said region 17 of action, from which sensitive region the light generated or emitted by the excited sample in the cytometer channel 7 is registered in the detector arrangement 8—together with other light from the sensitive region 18 such as, for example, light from an intrinsic fluorescence of the sample carrier 3.

For fine adjustment, it is necessary to coordinate or align the sensitive region 18 with the actual position of the cytometer channel 7. To that end, the mirror arrangement 12 can be pivoted in such a way that the sensitive region 18 is displaceable transversely with respect to an extension direction of the cytometer channel 7, that is to say along the X-axis in FIG. 2.

A feedback loop known per se, which is not illustrated in further detail, is connected to the detector arrangement 8 and evaluates an output signal of the detector arrangement 8 and drives the alteration means 16 such that the output signal has an improved intensity and/or an improved signal-to-noise ratio. In this case, it will happen that the sensitive region 18 is displaced away from the cytometer channel 7 into the material of the sample carrier 3.

However, since the optical path 4 has a comparatively large dimensioning in cross section in this adjustment direction (X-axis), this adjustment movement does not lead out from the already bleached region 10. A disturbance of the output signal by an intrinsic fluorescence of the material of the sample carrier 3 is thus avoided.

It is evident in FIG. 2 that the sensitive region 18 is contained completely in the region 17 of action. The light curtain already mentioned is implemented such that the first extent along the X-axis is greater than the second extent along the Y-axis, wherein the size of the cross section along the first extent is coordinated with the size of the sensitive region 18 and the size of the second extent of the cross section is coordinated with the size of the region 17 of action. What is thus achieved is that along the cytometer channel 7 only a comparatively short section given by the extent of the sensitive region 18 is excited and measured.

As already mentioned, the position of the optical path 4 on the sample carrier 3 is finely adjusted by the alteration means 16. In this case, the sample carrier 3 is pressed and fixed against a support 20 by a holding-down device 19. In the cytometry method according to the invention, therefore, the sample carrier 3 having a sample contained in the cytometer channel 7 is introduced into the optical path 4. Said optical path 4 defines the region 17 of action for the laser light 6 on the sample carrier 3. The laser light 6 excites the sample, as a result of which the sample itself emits light. This light is collected in the detector arrangement 8, wherein the configuration of the detector arrangement 8 distinguishes a sensitive region 18 on the sample carrier, from which the light is measured. During this cytometric measurement, the fluorescent, light-transmissive material of the sample carrier 3 is bleached by action of light in the region 10 around the cytometer channel 7.

In the meantime, in a feedback loop, the position of the optical path 4 is coordinated with the position of the cytometer channel 7 in such a way that the output signal of the detector arrangement 8 has an improved signal quality. In this case, the adjustment of the optical path 4 is carried out in a direction transversely with respect to the extension direction of the cytometer channel 4 in which the cross section of the optical path 4 has its largest extent. In this case, the region 17 of action projects beyond the sensitive region 18 in such a way that the fluorescent material of the sample carrier 3 is bleached by action of light in that part of the region 17 of action into which the sensitive region 18 is intended to be brought by alteration of the position of the optical path 4.

The invention also includes a use of a preferably sheet-shaped sample carrier 3, in particular as described above, in a cytometer unit 1 according to the invention, in particular as described above. In this case, provision can be made for the use to enable performance of the cytometry method according to the invention.

In the case of the cytometer unit 1 comprising a receptacle 2, which is configured for the insertion of a preferably sheet-shaped, exchangeable sample carrier 3 and in which an optical path 4 for carrying out a cytometric measurement is implemented, it is proposed to bleach the sample carrier 3 in a region 10 around a sensitive region 18 predefined by a detector arrangement 8 and/or to alter a position of the optical path 4 on the inserted sample carrier 3 using an alteration means 16.

### LIST OF REFERENCE SIGNS

1 cytometer unit
2 receptacle
3 sample carrier
4 optical path
5 laser light generator
6 laser light
7 cytometer channel
8 detector arrangement
9 means for bleaching
10 (bleached) region
11 lens arrangement
12 mirror arrangement
13 cylindrical lens
14 objective lens
15 pivoting
16 alteration means
17 region of action
18 sensitive region
19 holding-down device
20 support
21 means for illuminating
22 rotation unit

1. A cytometry method, comprising, for a cytometric measurement, introducing a cytometer channel (7) embodied in a sample carrier (3) and containing a sample to be examined into an optical path (4), in which the optical path (4) defines a region (17) of action on the sample carrier (3) and a detector arrangement (8) defines a sensitive region (18) on the sample carrier (3), the sample carrier (3) includes a fluorescent, light-transmissive material at least in a region of the cytometer channel (7), and bleaching the fluorescent, light-transmissive material by action of light before the cytometric measurement.

2. The cytometry method as claimed in claim 1, wherein in the cytometric measurement, the cytometer channel (7) implemented in the sample carrier (3) and containing the sample to be examined that is introduced into the optical path (4), in which the optical path (4) defines the region (17) of action on the sample carrier (3) and the detector arrangement (8) defines the sensitive region (18) on the sample carrier (3), the method further comprises altering a position of the optical path (4) on the sample carrier (3) before the cytometric measurement such that an output signal of the detector arrangement (8) has an improved signal quality.

3. The cytometry method as claimed in claim 1, wherein the fluorescent material of the sample carrier (3) is bleached by action of light in a part of the region (17) of action into which the sensitive region (18) is brought by the alteration of the position of the optical path (4).

4. The cytometry method as claimed in claim 2, wherein the position of the optical path (4) is altered by an adjustable mirror arrangement (12) or the position of the optical path (4) is set by a feedback loop coupled to the output signal.

5. The cytometry method as claimed in claim 1, wherein the region (17) of action covers the sensitive region (18) or the position of the optical path (4) is altered transversely with respect to an extension direction of the cytometer channel (7).

6. The cytometry method as claimed in claim 1, further comprising illuminating the region (17) of action with a light curtain having a cross section that has a first extent along an extension direction of the cytometer channel (7) and a second extent transversely with respect to the extension direction of the cytometer channel (7), and at least one of: the first extent is smaller than the second extent, the first extent is coordinated with a size of the sensitive region (18), or the second extent is coordinated with a size of the region (17) of action.

7. A cytometer unit (1), comprising a receptacle for an insertable sample carrier (3), a rotation unit (22) which is couplable to an inserted sample carrier (3) arranged in the receptacle (2), by which rotation unit the sample carrier (3) inserted into the receptacle (2) is rotatable, an optical path (4) for carrying out a cytometric measurement on a cytometer channel (7) of the inserted sample carrier (3) is implemented in the receptacle (2), and a bleaching device that bleaches (9) the sample carrier (3) at least in a region (10) around the cytometer channel by action of light.

8. The cytometer unit (1) as claimed in claim 7, wherein the bleaching device (9) comprises at least one of a beam-shaping lens arrangement (11) or an adjustable mirror arrangement (12).

9. The cytometer unit (1) as claimed in claim 7, comprising an alteration device (16) that alters a position of the optical path (4) on the inserted sample carrier (3).

10. The cytometer unit (1) as claimed in claim 9, wherein the alteration device (16) comprises an adjustable mirror arrangement (12).

11. The cytometer unit (1) as claimed in claim 9, further comprising a feedback loop coupled to an output signal of a detector arrangement (8) that performs the cytometric measurement that is configured to drive the alteration device (16).

12. The cytometer unit (1) as claimed in claim 7, wherein the region (17) of action is implemented such that it is larger than the sensitive region (18).

13. The cytometer unit (1) as claimed in claim 7, further comprising a light curtain that illuminates the region (17) of action, the light curtain has a cross section having a first extent along an extension direction of the cytometer channel and a second extent transversely with respect to the extension direction of the cytometer channel (7), and the first extent is smaller than the second extent.

14. The cytometer unit (1) as claimed in claim 7, wherein an adjustability of a sensitive region (18) defined by a detector arrangement (8) is delimited by the region (10) around the cytometer channel (7).

15. The cytometer unit (1) as claimed in claim 9, wherein the alteration device (16) is configured for adjusting a position of at least one of a sensitive region (18) or a region (17) of action on the inserted sample carrier (3) transversely with respect to an extension direction of the cytometer channel (7).

16. The cytometer unit (1) as claimed in claim 13, wherein at least one of the first extent is coordinated with a size of the sensitive region (18) or the second extent is coordinated with a size of the region (17) of action.
